(19) United States
(12) Patent Application Publication
(10) Pub. No.: US 2020/0074065 A1
(43) Pub. Date: Mar. 5, 2020

(54) INTEGRATED IDENTIFICATION AND AUTHENTICATION FOR CAR SHARING AND TAXI SERVICE

(71) Applicant: GM GLOBAL TECHNOLOGY OPERATIONS LLC, Detroit, MI (US)

(72) Inventors: Wende Zhang, Birmingham, MI (US); Esther Anderson, Canton, MI (US); Eric Hatfield, Clinton Township, MI (US); Adrienne M. Williamson, Rochester Hills, MI (US)

(73) Assignee: GM GLOBAL TECHNOLOGY OPERATIONS LLC, Detroit, MI (US)

(21) Appl. No.: 16/114,698

(22) Filed: Aug. 28, 2018

(51) Int. Cl. G06F 21/36; G06F 3/0488; G06K 9/00; G05D 1/00; G01C 21/34; G06Q 10/02; G06Q 50/30

(52) U.S. Cl. CPC G06F 21/36; G06F 3/04883; G06K 9/00288; G05D 2201/0213; G01C 21/3438; G06Q 10/02; G06Q 50/30; G05D 1/0088

(57) ABSTRACT

Methods and systems are provided for interacting with a user of a vehicle. In one embodiment, a method includes: receiving first sensor data indicating a scene of an environment within a vicinity of the vehicle; processing, by a processor, the first sensor data to determine a first gesture of an individual in the scene; recommending, by the processor, a second gesture to the individual; receiving, by the processor, second sensor data indicating a scene of an environment of the vehicle; processing, by the processor, the second sensor data to determine a third gesture of the individual in the scene; comparing, by the processor, the second gesture and the third gesture; selectively identifying, by the processor, the individual as a user or not a user of the vehicle based on the comparing; and controlling, by the processor, the vehicle towards or away from the user based on the identifying.

### TECHNICAL FIELD

The technical field generally relates to transportation systems, and more particularly relates to methods and systems for integrating identification and authentication for car sharing and taxi service provided by a transportation system.

Application based transportation systems are becoming increasingly popular. Conventional application based transportation systems connect a user with a local driver and/or vehicle who is available to take the user from point A to point B. In some instances, the driver uses their own personal vehicle or uses a vehicle that is one of a fleet of commercially owned vehicles to transport the user.

In some instances, an autonomous vehicle is used instead of a driver based vehicle to transport the user. An autonomous vehicle is, for example, a vehicle that is capable of sensing its environment and navigating with little or no user input. An autonomous vehicle senses its environment using sensing devices such as radar, lidar, image sensors, etc. The autonomous vehicle further uses information from global positioning systems (GPS) technology, navigation systems, and/or drive-by-wire systems to navigate the vehicle.

When deploying both a driver based vehicle and an autonomous vehicle, it is desirable to both identify and authenticate a user of the transportation system before a ride begins. It is further desirable to identify and authenticate a vehicle of the transportation system before the ride begins. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for interacting with a user of a vehicle. In one embodiment, a method includes: receiving first sensor data indicating a scene of an environment within a vicinity of the vehicle; processing, by a processor, the first sensor data to determine a first gesture of an individual in the scene; recommending, by the processor, a second gesture to the individual; receiving, by the processor, second sensor data indicating a scene of an environment of the vehicle; processing, by the processor, the second sensor data to determine a third gesture of the individual in the scene; comparing, by the processor, the second gesture and the third gesture; selectively identifying, by the processor, the individual as a user or not a user of the vehicle based on the comparing; and controlling, by the processor, the vehicle towards or away from the user based on the identifying.

In various embodiments, the processing the first sensor data further includes: receiving gesture data generated by a hand-held device; identifying the individual in the scene based on the first sensor data; and determining the first gesture of the individual based on the gesture data generated by the hand-held device.

In various embodiments, the processing the second sensor data further includes: receiving gesture data generated by a hand-held device; identifying the individual in the scene based on the second sensor data; and determining the third gesture of the individual based on the gesture data generated by the hand-held device.

In various embodiments, the recommending the second gesture is performed when the first gesture of the individual is not approximately the same as an expected gesture. In various embodiments, the method includes determining the second gesture as a gesture that is different than the first gesture and the expected gesture.

In various embodiments, the recommending the second gesture is performed when the first gesture of the individual and a gesture of a second individual are approximately the same as an expected gesture.

In various embodiments, the recommending the second gesture to the individual includes generating a second signal indicating the second gesture to a hand-held device associated with the individual. In various embodiments, the method includes: presenting the first gesture to an occupant of the vehicle; selectively identifying the individual as a user or not a user of the vehicle based on feedback received from the occupant of the vehicle; and wherein the controlling the vehicle towards or away from the user is further based on the identifying.

In various embodiments, the presenting the first gesture is by way of a display system of the vehicle, and wherein the feedback is received by way of the display system of the vehicle. In various embodiments, the first sensor data includes image data and wherein the method further comprises identifying the individual based on a location and an identified gesture, motion, or facial feature of an individual within the image data.

In another embodiment, a transportation system is provided. The transportation system includes a fleet of vehicles; and a user interaction system including a computer readable medium and a processor. The user interaction system is configured to, by the processor: receive first sensor data indicating a scene of an environment within a vicinity of a first vehicle; process, by a processor, the first sensor data to determine a first gesture of an individual in the scene; recommend, by the processor, a second gesture to the individual; receive, by the processor, second sensor data indicating a scene of an environment of the first vehicle; process, by the processor, the second sensor data to determine a third gesture of the individual in the scene; compare, by the processor, the second gesture and the third gesture; selectively identify, by the processor, the individual as a user or not a user of the first vehicle based on the comparing; and control, by the processor, the first vehicle towards or away from the user based on the identifying.

In various embodiments, the user interaction system is further configured to process the first sensor data by: receiving gesture data generated by a hand-held device; identifying the individual in the scene based on the first sensor data; and determining the first gesture of the individual based on the gesture data generated by the hand-held device.

In various embodiments, the user interaction system is further configured to process the second sensor data by: receiving gesture data generated by a hand-held device; identifying the individual in the scene based on the second sensor data; and determining the third gesture of the individual based on the gesture data generated by the hand-held device.

In various embodiments, the user interaction system is further configured to recommend the second gesture when the first gesture of the individual is not approximately the same as an expected gesture.

In various embodiments, the user interaction system is further configured to determine the second gesture as a gesture that is different than the first gesture and the expected gesture.

In various embodiments, the user interaction system is further configured to recommend the second gesture when the first gesture of the individual and a gesture of a second individual are approximately the same as an expected gesture.

In various embodiments, the user interaction system is further configured to recommend the second gesture to the individual by generating a second signal indicating the second gesture to a hand-held device associated with the individual.

In various embodiments, the user interaction system is further configured to: present the first gesture to an occupant of the first vehicle; selectively identify the individual as a user or not a user of the first vehicle based on feedback received from the occupant of the first vehicle; and control the first vehicle towards or away from the user further based on the identifying.

In various embodiments, the user interaction system is further configured to present the first gesture by way of a display system of the first vehicle, and wherein the feedback is received by way of the display system of the first vehicle.

In various embodiments, the first sensor data includes image data and wherein he user interaction system is further configured to the identify the individual based on a location and an identified gesture, motion, or facial feature of an individual within the image data.

### DESCRIPTION OF THE DRAWINGS

The exemplary embodiments will hereinafter be described in conjunction with the following drawing figures, wherein like numerals denote like elements, and wherein:

FIG. 1 is a functional block diagram of transportation system having a user interaction system in accordance with various embodiments;

FIG. 2 is functional block diagram of a user device that communicates with the user interaction system in accordance with various embodiments;

FIG. 3 functional block diagram of a vehicle of the transportation system and that communicates with the user interaction system in accordance with various embodiments; and

FIG. 4 is a flowchart that illustrates a user interaction method that can be performed by the user interaction system in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the disclosure may be described herein in terms of functional and/or logical block components and various processing steps. It should be appreciated that such block components may be realized by any number of hardware, software, and/or firmware components configured to perform the specified functions. For example, an embodiment of the disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of transportation control systems, and that the vehicle system described herein is merely one example embodiment of the invention.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

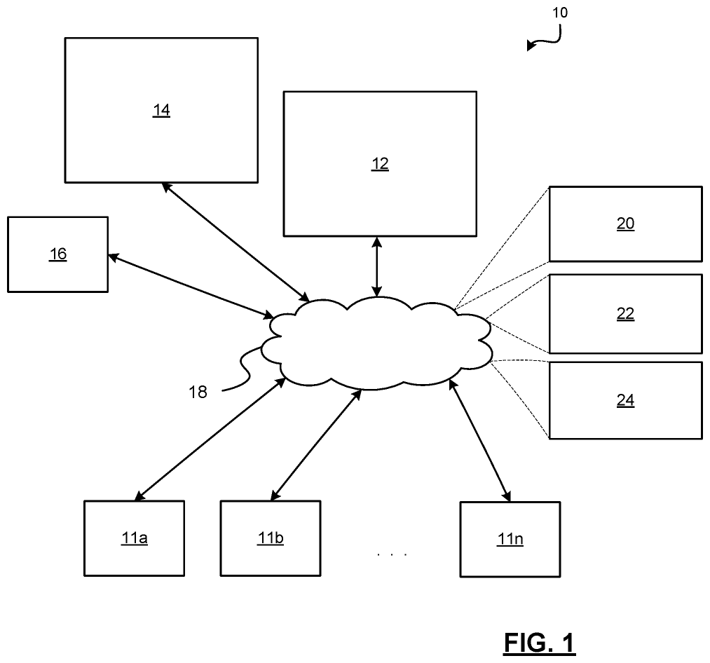

With initial reference to FIG. 1, an exemplary embodiment of an operating environment is shown generally at 10 that includes a transportation system 12 that is associated with one or more vehicles 11a-11n. The transportation system 12 may be suitable for use in the context of a taxi or shuttle service in a certain geographical area (e.g., a city, a school or business campus, a shopping center, an amusement park, an event center, or the like) or may simply manage ride sharing for one or more vehicles 11a-11n.

In various embodiments, the transportation system 12 includes one or more backend server systems having at least memory and one or more processors, which may be cloud-based, network-based, or resident at the particular campus or geographical location serviced by the transportation system 12. The transportation system 12 can be manned by a live advisor, or an automated advisor, or a combination of both. The transportation system 12 schedule rides, dispatches vehicles 11a-11n, and the like.

In various embodiments, the transportation system 12 stores in the memory subscriber account information and/or vehicle information. The subscriber account information can include, but is not limited to, biometric data, password information, subscriber preferences, and learned behavioral patterns. The vehicle information can include, but is not limited to, vehicle attributes such as color, make, model, license plate number, notification light pattern, and/or frequency identifiers. In various embodiments, the transportation system 12 stores in the memory defined maps of the navigable environment.

The transportation system 12 is further associated with a user interaction system 14 that is configured to identify and authenticate a user intending to ride in at least one of the vehicles 11a-11n and likewise to identify and authenticate the vehicle 11a intending to provide the ride to the user through the ride sharing and/or taxi service. The user interaction system 14 may be implemented as a stand-alone system (as shown), may be implemented solely on the transportation system 12, may be implemented partly on the transportation system 12 and partly on the vehicles 11a-11n, or may be implemented solely on one or more of the vehicles 11a-11n.

In order to identify and/or authenticate the user and/or the vehicle 11a, the operating environment 10 further includes one or more user devices 16 that communicate with the vehicles 11a-11n, the transportation system 12, and/or the user interaction system 14 via a communication network 18. In various embodiments, the communication network 18 supports communication as needed between devices, systems, and components supported by the operating environment 10 (e.g., via tangible communication links and/or wireless communication links). For example, the communication network 18 can include a wireless carrier system 20 such as a cellular telephone system that includes a plurality of cell towers (not shown), one or more mobile switching centers (MSCs) (not shown), as well as any other networking components required to connect the wireless carrier system 20 with a land communications system. Each cell tower includes sending and receiving antennas and a base station, with the base stations from different cell towers being connected to the MSC either directly or via intermediary equipment such as a base station controller. The wireless carrier system 20 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 20. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 20, a second wireless carrier system in the form of a satellite communication system 22 can be included to provide uni-directional or bi-directional communication with the vehicles 11a-11n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 11a and the station. The satellite telephony can be utilized either in addition to or in lieu of the wireless carrier system 20.

A land communication system 24 may further be included that is a conventional land-based telecommunications network connected to one or more landline telephones and connects the wireless carrier system 20 to the transportation system 12. For example, the land communication system 24 may include a public switched telephone network (PSTN) such as that used to provide hardwired telephony, packet-switched data communications, and the Internet infrastructure. One or more segments of the land communication system 24 can be implemented through the use of a standard wired network, a fiber or other optical network, a cable network, power lines, other wireless networks such as wireless local area networks (WLANs), or networks providing broadband wireless access (BWA), or any combination thereof. Furthermore, the transportation system 12 need not be connected via the land communication system 24, but can include wireless telephony equipment so that it can communicate directly with a wireless network, such as the wireless carrier system 20.

Although only one user device 16 is shown in FIG. 1, embodiments of the operating environment 10 can support any number of user devices 16, including multiple user devices 16 owned, operated, or otherwise used by one person. Each user device 16 supported by the operating environment 10 may be implemented using any suitable hardware platform. In this regard, the user device 16 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 16 supported by the operating environment 10 is realized as a computer-implemented or computer-based device having the hardware, software, firmware, and/or processing logic needed to carry out the various techniques and methodologies described herein.

For example, as shown in FIG. 2, the user device 16 includes a microprocessor 30 in the form of a programmable device that includes one or more instructions stored in an internal memory structure and applied to receive binary input to create binary output. In various embodiments, the user device 16 includes a GPS module 32 capable of receiving GPS satellite signals and generating GPS coordinates based on those signals. In various embodiments, the user device 16 includes cellular communications module 34 such that the device carries out communications over the communication network 18 using one or more communications protocol as are discussed herein. In various embodiments, the user device 16 includes a display system 36, such as a touch-screen graphical display, or other display. In various embodiments, the user device 16 includes one or more sensors 38 such as, but not limited to, an image sensor (e.g. a camera or other imaging device), an accelerometer, a voice recorder, and/or other sensor devices capable of capturing a gesture of the user.

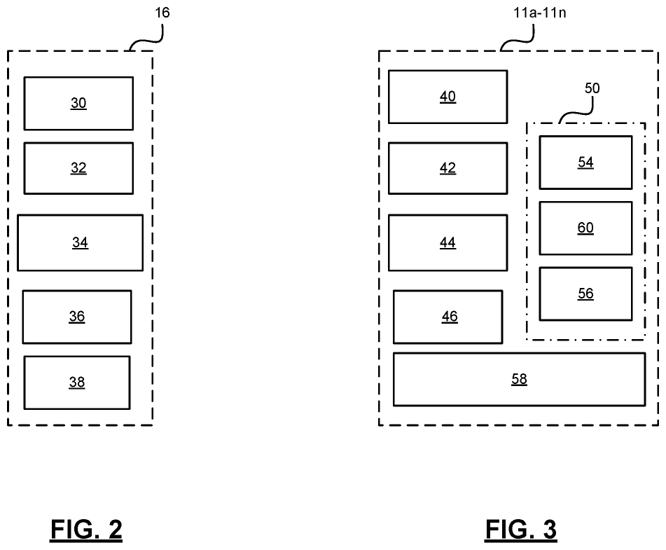

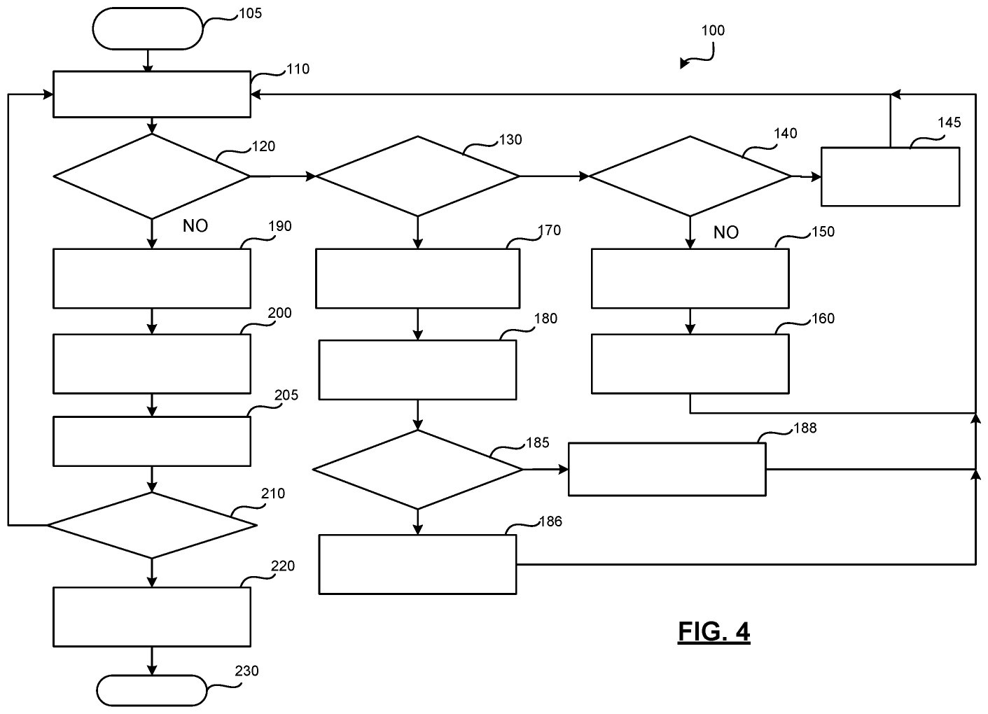

The vehicles 11a-11n are similarly realized as having a computer-implemented or computer-based system having the hardware, software, firmware, and/or processing logic needed to carry out the various techniques and methodologies described herein. For example, as shown in FIG. 3, the vehicles 11a-11n each include a processor and associated memory 40, and a global positioning system (GPS) module 42 capable of receiving GPS satellite signals and generating GPS coordinates based on those signals. In various embodiments, the vehicles 11a-11n each include a communications module 44 such that the vehicle carries out communications over the communication network 18 using one or more communications protocols as are discussed herein. In various embodiments, the vehicles 11a-11n each include a display system 46, such as a touch-screen graphical display, or other display that displays identification and/or authentication information to a user and/or driver.

In various embodiments, the vehicles 11a-11n further include, among other features, one or more sensors 50 that sense an element of an environment of the vehicle 11a and that generate sensor signals based thereon. In various embodiments, the sensors 50 include exterior sensors 54 that sense elements outside of the vehicle 11a-11n and can include, but are not limited to, radars, lidars, optical cameras, thermal cameras, ultrasonic sensors, inertial measurement units, and/or other sensors. In various embodiments, the sensors 50 include interior sensors 56 that sense elements inside of the vehicle 11a-11n and can include, but are not limited to, radars, lidars, optical cameras, thermal cameras, ultrasonic sensors, inertial measurement units, and/or other sensors.

In various embodiments, the sensor signals generated by the exterior sensors 54 are used by one or more control systems 58 to control the driving functions of the vehicles 11a-11n. When the vehicles 11a-11n are an automobile, the control systems 58 can include, but are not limited to, a parking system, a vehicle cruise system, a lane keeping system, a lane change system, a vehicle steering system, etc. As can be appreciated, the control systems 58 described herein are merely exemplary, as any control system associated with providing full or partial autonomy can be included, in various embodiments. In addition, in various embodiments, the vehicles 11a-11n can be controlled by commands, instructions, and/or inputs that are “self-generated” onboard the vehicles 11a-11n. Alternatively or additionally, the vehicles 11a-11n can be controlled by commands, instructions, and/or inputs that are generated by one or more components or systems external to the vehicles 11a-11n, including, without limitation: other autonomous vehicles; a backend server system; a control device or system located in an external operating environment associated with the vehicles 11a-11n; or the like. In certain embodiments, therefore, a given vehicle 11a can be controlled using vehicle-to-vehicle data communication, vehicle-to-infrastructure data communication, and/or infrastructure-to-vehicle communication.

As will be discussed in more detail below, the sensor signals generated by the exterior sensors 54 and/or the interior sensors 56 can be further used by the user interaction system 14 (FIG. 1) to identify and/or authenticate the user and/or the vehicle 11a selected to provide the ride to the user.

In various embodiments, the sensors 50 further include biometric sensors 60 that sense an element or a feature of an individual in proximity to the vehicle 11a and that generate sensor signals based thereon. In various embodiments, the biometric sensors 60 can include, but are not limited to, fingerprint detection sensors, voice detection sensors, iris detection sensors, face detection sensors, and the like. The biometric sensors 60 can be exterior sensors that sense individuals outside of the vehicle 11a and/or can be interior sensors that sense individuals inside of the vehicle 11a. As will be discussed in more detail below, the sensor signals generated by the biometric sensors 60 are used by the user interaction system 14 (FIG. 1) to identify and/or authenticate a user and/or the selected vehicle 11a.

With reference back to FIG. 1, in accordance with a typical use case workflow, a registered user of the transportation system 12 can create a ride request via the user device 16. The ride request will typically indicate the passenger's desired pickup location (or current GPS location), the desired destination location (which may identify a predefined vehicle stop and/or a user-specified passenger destination), and a pickup time. The transportation system 12 receives the ride request, processes the request, and dispatches a selected one of the vehicles 11a-11n (when and if one is available) to pick up the passenger at the designated pickup location and at the appropriate time. The transportation system 12 can also generate and send a suitably configured confirmation message or notification to the user device 16, to let the passenger know that the selected one of the vehicles 11a-11n is on the way.

As the selected one of the vehicles 11a approaches the registered user, the user interaction system 14 identifies the user to the vehicle 11a, identifies the selected vehicle 11a to the user, authenticates the user, and authenticates the vehicle 11a before beginning the ride. The user interaction system 14 selectively performs the identification and the authentication based on a time and/or a distance determined between the user and the selected vehicle 11a. The user interaction system 14 selectively performs the identification and/or the authentication of the user based on gestures recognized by the user device, the vehicle, and/or occupants of the vehicle 11a.

Once the identification and authentication is complete, the user may enter parameters for selecting a next rider. The entered parameters may be used by the identification and/or authentication process for the next rider.

As shown in more detail with regard to FIG. 4 and with continued reference to FIGS. 1, 2, and 3, a flowchart illustrates a method 100 of user interaction that may be performed by the user interaction system 14 in accordance with exemplary embodiments. As can be appreciated in light of the disclosure, the order of operation within the method is not limited to the sequential execution as illustrated in FIG. 4, but may be performed in one or more varying orders as applicable and in accordance with the present disclosure. In various embodiments, the method 100 may be schedule to run upon request by a user of a ride in one of the vehicles 11a-11n of the fleet of the transportation system 12.

In various embodiments, the method may begin at 105. The approximate or rough distance between the user and the vehicle 11a is determined at 110. For example, the distance can be determined from GPS location information from both the user device 16 and the vehicle 11a. As can be appreciated, in various embodiments the time between the user and the vehicle 11a can be computed and evaluated instead of or in addition to the distance. The time can take into account route, traffic information, road hazards, obstacles, etc. between the user and the vehicles 11a. For exemplary purposes, the remainder of the flowchart will be discussed in the context of the determined distance.

At 120-140, the distance is evaluated to see if it falls within ranges defined by predefined thresholds. For example, if the distance is greater than a first predefined threshold (e.g., 1 meter or some other value) at 120, the distance is greater than a second predefined threshold (e.g., 10 meters or some other value) at 130, and the distance is greater than a third predefined threshold (e.g. 100 meters or some other value), the vehicle is still too far away for identification and the method continues with monitoring the distance at 110.

If, however, the distance is greater than the first predetermined threshold at 120, greater than the second predefined threshold at 130, but less than the third predefined threshold at 140 (e.g., within a first range), then the user is localized at 150 and the vehicle is localized at 160. For example, the user may be localized using localization methods that are based on, for example, GPS information provided by the user device 16 and/or processing of image sensor data provided by the user device 16 with stored map information. Similarly, the vehicle 11a may be localized using localization methods that are based on, for example, GPS information provided by the vehicle 11a and/or processing of lidar, radar, and/or data provided by the vehicle 11a with stored map information. Thereafter, the distance is monitored at 110.

If, at 120, the distance is greater than the first predetermined threshold, and less than the second predefined threshold at 130 (e.g., within a second range), then the user is identified by the vehicle 11a at 170 as the rider. For example, the user may be identified by the vehicle 11a based on information provided by the vehicle 11a and/or information provided by the user device 16. In various embodiments, the user may be identified by processing lidar, radar, and/or image data provided by the sensors 54 to identify a location, face, gesture, motion, and/or other features of the individual. In various embodiments, the user may be identified by processing image data, motion data, and/or biometric data provided by the sensors 38 to identify a location, face, gesture, motion, and/or other features of the individual.

In various embodiments, the identified features can be compared with stored features of the user profile and/or other parameters entered by a previous rider (e.g., expected location, face, gesture, motion, and/or other features of the individual). In various embodiments, the user may be further identified by communicating an expected gesture or motion to the user and comparing a sensed gesture or motion with the expected gesture or motion. The communication of the expected gesture or motion can be based on an identification of two or more users performing the same gesture or motion or an identification of one user performing a gesture or motion but it is not the same as an expected gesture or motion.

In various embodiments, the user may be further identified based on a confidence factor determined based on the processing (e.g., by fusing confidence factors of each identification of location, face, gesture and/or motion using, for example, a Bayesian approach or some other fusion technique). The confidence factor is then compared to a threshold, to confirm identification of the rider. In various embodiments, to confirm the identification of the rider to a driver or other occupant of the vehicle 11a, the identified individual is highlighted, circled, or identified in an otherwise visual manner on a real time video scene displayed by the display system 46 of the vehicle 11a.

Thereafter, the vehicle 11a is identified by the user device at 180 as the vehicle selected to provide the ride. For example, the vehicle 11a may be identified by processing image data provided by the user device 16 to identify a model, color license plate number, vehicle exterior light patterns and/or frequencies, or other exterior attributes. The identified features can be compared with stored features of the user profile and/or other parameters entered by a previous rider. To confirm the identification to the user, the identified vehicle is highlighted, circled, or identified in an otherwise visual manner on the real time video scene displayed by the display system 36 of the user device 16.

If the rider is identified at 185, the vehicle 11a moves forward towards the rider at 186. If, however, the rider is not identified at 185, the vehicle 11a may remain stationary or continue forward until the rider is identified at 188. Thereafter, the method continues with monitoring the distance at 110. If the user was not identified due to user entered preferences, optionally, a message can be sent to the user and a new vehicle can be requested for user. Thereafter, the method continues with monitoring the distance at 110.

If, at 120, the distance is less than the first predetermined threshold (e.g., within a third range), the identified rider is authenticated at 190 and the identified vehicle is authenticated at 200. For example, in various embodiments, the rider may be authenticated by the vehicle 11a by verifying biometric information sensed from the identified rider by one or more of the biometric sensors 60 of the vehicle 11a. The biometric sensor data may be compared with stored biometric information in the user profile of the transportation system 12. In another example, in various embodiments, the rider may be authenticated by the vehicle 11a by verifying user device data (e.g., provided by near field communication) to touch and/or unlock a door. The user device date may be compared with stored information in the user profile of the transportation system 12. In another example, the rider may be authenticated by the vehicle 11a by verifying information provided by the applications on the user device such as, but not limited to, social media information, parent authentication/approval information, voice profiles, etc.

In another example, the vehicle 11a may be authenticated by verifying stored information (i.e., a vehicle identification number, vehicle fleet number, etc.) or verifying sensed information (e.g., light pattern, driver face, driver palm or fingerprint, etc.). The sensed information can be captured by the interior sensors 56 of the vehicle 11a and/or the sensors 38 of the user device 16.

For example, the vehicle 11a may be authenticated by processing sensor data provided by the vehicle 11a to identify interior characteristics of the vehicle 11a and/or of the driver such as, but not limited to, a vehicle identification number, vehicle fleet number, vehicle interior light patterns and/or frequencies, or other interior attributes. To confirm the identification to the user, the identified vehicle and/or driver is highlighted, circled, or identified in an otherwise visual manner on the real time video scene displayed by the display system 36 of the user device 16. In various embodiments, once the rider has been authenticated, the rider may enter parameters for selecting a next rider to share in the ride of the vehicle 11a at 205. For example, the rider may enter through the user device a preference of a gender (male or female), an age (child, teen, senior, etc.), or other characteristic of a user that may be identifiable through the user device and/or the sensors of the vehicle. The parameters are then used in the next iteration of the method to identify the next rider.

Once it is determined that the identified rider is inside the vehicle 11a at 210, a billing system for coordinating payment for the ride may be performed or some other action to commence the ride may be performed at 220 and the method may end at 230.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of interacting with a user of a vehicle, comprising:
receiving first sensor data indicating a scene of an environment within a vicinity of the vehicle;
processing, by a processor, the first sensor data to determine a first gesture of an individual in the scene;
recommending, by the processor, a second gesture to the individual;
receiving, by the processor, second sensor data indicating a scene of an environment of the vehicle;
processing, by the processor, the second sensor data to determine a third gesture of the individual in the scene;
comparing, by the processor, the second gesture and the third gesture;
selectively identifying, by the processor, the individual as a user or not a user of the vehicle based on the comparing; and
controlling, by the processor, the vehicle towards or away from the user based on the identifying.

2. The method of claim 1, wherein the processing the first sensor data further comprises:
receiving gesture data generated by a hand-held device;
identifying the individual in the scene based on the first sensor data; and
determining the first gesture of the individual based on the gesture data generated by the hand-held device.

3. The method of claim 1, wherein the processing the second sensor data further comprises:
receiving gesture data generated by a hand-held device;
identifying the individual in the scene based on the second sensor data; and
determining the third gesture of the individual based on the gesture data generated by the hand-held device.

4. The method of claim 1, wherein the recommending the second gesture is performed when the first gesture of the individual is not approximately the same as an expected gesture.

5. The method of claim 4, further comprising determining the second gesture as a gesture that is different than the first gesture and the expected gesture.

6. The method of claim 1, wherein the recommending the second gesture is performed when the first gesture of the individual and a gesture of a second individual are approximately the same as an expected gesture.

7. The method of claim 1, wherein the recommending the second gesture to the individual comprises generating a second signal indicating the second gesture to a hand-held device associated with the individual.

8. The method of claim 1, further comprising:
presenting the first gesture to an occupant of the vehicle;
selectively identifying the individual as a user or not a user of the vehicle based on feedback received from the occupant of the vehicle; and
wherein the controlling the vehicle towards or away from the user is further based on the identifying.

9. The method of claim 8, wherein the presenting the first gesture is by way of a display system of the vehicle, and wherein the feedback is received by way of the display system of the vehicle.

10. The method of claim 1, wherein the first sensor data includes image data and wherein the method further comprises identifying the individual based on a location and an identified gesture, motion, or facial feature of an individual within the image data.

11. A transportation system, comprising:
a fleet of vehicles; and
a user interaction system including a computer readable medium and a processor, wherein the user interaction system is configured to, by the processor:
receive first sensor data indicating a scene of an environment within a vicinity of a first vehicle of the fleet of vehicles;
process, by a processor, the first sensor data to determine a first gesture of an individual in the scene;
recommend, by the processor, a second gesture to the individual;
receive, by the processor, second sensor data indicating a scene of an environment of the first vehicle;
process, by the processor, the second sensor data to determine a third gesture of the individual in the scene;
compare, by the processor, the second gesture and the third gesture;
selectively identify, by the processor, the individual as a user or not a user of the first vehicle based on the comparing; and
control, by the processor, the first vehicle towards or away from the user based on the identifying.

12. The transportation system of claim 11, wherein the user interaction system is further configured to process the first sensor data by:
receiving gesture data generated by a hand-held device;
identifying the individual in the scene based on the first sensor data; and
determining the first gesture of the individual based on the gesture data generated by the hand-held device.

13. The transportation system of claim 11, wherein the user interaction system is further configured to process the second sensor data by:
receiving gesture data generated by a hand-held device;
identifying the individual in the scene based on the second sensor data; and
determining the third gesture of the individual based on the gesture data generated by the hand-held device.

14. The transportation system of claim 11, wherein the user interaction system is further configured to recommend the second gesture when the first gesture of the individual is not approximately the same as an expected gesture.

15. The transportation system of claim 14, wherein the user interaction system is further configured to determine the second gesture as a gesture that is different than the first gesture and the expected gesture.

16. The transportation system of claim 11, wherein the user interaction system is further configured to recommend the second gesture when the first gesture of the individual and a gesture of a second individual are approximately the same as an expected gesture.

17. The transportation system of claim 11, wherein the user interaction system is further configured to recommend the second gesture to the individual by generating a second signal indicating the second gesture to a hand-held device associated with the individual.

18. The transportation system of claim 11, wherein the user interaction system is further configured to:
present the first gesture to an occupant of the first vehicle;
selectively identify the individual as a user or not a user of the first vehicle based on feedback received from the occupant of the first vehicle; and
control the first vehicle towards or away from the user further based on the identifying.

19. The transportation system of claim 18, wherein the user interaction system is further configured to present the first gesture by way of a display system of the first vehicle, and wherein the feedback is received by way of the display system of the first vehicle.

20. The transportation system of claim 11, wherein the first sensor data includes image data and wherein the user interaction system is further configured to the identify the individual based on a location and an identified gesture, motion, or facial feature of an individual within the image data.
